(19) United States
(12) Patent Application Publication
(10) Pub. No.: US 2008/0057376 A1
(43) Pub. Date: Mar. 6, 2008

(54) Fuel-Cell Stack Comprising an External Media Supply

(75) Inventors: Stefan Haufe, Gottingen (DE); Annette Reiche, Goettingen (DE); Dieter Melzner, Goettingen (DE); Fabian Walter, Goettingen (DE)

Correspondence Address: CASELLA & HESPOS, 274 MADISON AVENUE, NEW YORK, NY, 10016, US

(73) Assignee: Sartorius AG, Goettingen (DE)

(21) Appl. No.: 11/666,968

(22) PCT Filed: Nov. 8, 2005
(86) PCT No.: PCT/EP05/11913

§ 371 Date: May 2, 2007

(30) Foreign Application Priority Data
Nov. 13, 2004 (DE) 20 2004 017 647.5

(51) Int. Cl. H01M 8/24

(52) U.S. Cl. 429/36

(57) ABSTRACT

The invention relates to a fuel-cell stack with an external media supply, comprising a plurality of stacked fuel-cell elements, each containing a proton-conductive polymer membrane, which is located between a flat anode electrode and a flat cathode electrode, each electrode being in contact with a separator plate containing canal structures for supplying a reaction gas, evacuating superfluous reaction gas and water that has been produced and/or for distributing a heat transfer medium. At least one collection/distribution container, which is connected to the canal structures of a plurality of separator plates, distributes the reaction gas or the heat transfer medium or collects superfluous reaction gas and water that has been produced or the heat transfer medium. The collection/distribution container is configured as a hood that covers a plurality of fuel-cell elements, the edge of said hood being sealed in relation to the covered elements. The seal comprises at least a first sealing layer that is configured as a solid seal and a second sealing layer, which is in direct contact with the covered fuel-cell elements and at least partially compensates the offsets between the neighbouring fuel-cell elements, the second sealing layer consisting of a highly viscous plastic with permanent plastic characteristics.

The invention relates to a fuel-cell stack having an external media supply, having a plurality of stacked fuel cell elements which each contain a proton-conducting polymer membrane which is arranged between a flat anode electrode and a flat cathode electrode, which each make contact with a separator plate, which separator plate has channel structures for supplying reaction gas, for carrying away excess reaction gas and water that is created and/or for distribution of a heat carrier, and furthermore having at least one collection/distribution container which is connected to channel structures of a plurality of separator plates, for distribution of reaction gas or coolant or for collection of water or coolant that is being carried away, with the collection/distribution container being in the form of a shroud which covers a plurality of fuel cell elements and whose edge is sealed with respect to the fuel cell elements that are covered, with the seal having at least one first sealing layer, which is in the form of a solid seal, and a second sealing layer, which makes direct contact with the fuel cell elements being covered and at least partially compensates for steps between adjacent fuel cell elements.

A fuel cell arrangement such as this is known from U.S. Pat. No. 6,660,422 B2.

Various types of fuel cells are known, particularly in the case of so-called polymer electrolyte membrane fuel cells (PEMFCs Proton Electrolyte Membrane Fuel Cells), a proton-conductive membrane is provided, with which electrodes make contact on both sides. The electrodes normally have a catalytically active layer, for example composed of platinum-coated carbon black, which is in direct contact with the proton conductor, as well as porous, electronically conductive structures, which are used to transport the reaction gases to the catalytically active layer. The last-mentioned structures are normally referred to as gas diffusion structures. By way of example, they may be formed from porous carbon paper, fabric or non-woven. The membrane and electrode are normally in the form of an assembly, which is referred to as an MEA (Membrane-electrode-assembly).

For operation of the fuel cell, the electrode which acts as the anode is supplied with hydrogen gas or gas containing hydrogen. The precise composition of the gas depends on the specific configuration of the rest of the fuel cell.

At the same time, oxygen gas or gas containing oxygen is supplied to the second electrode, which acts as the cathode. The hydrogen is catalytically oxidized at the anode:
H₂→2H⁺+2e⁻.

The electrons released during this process are dissipated via the electrode to the load, and the resultant protons migrate through the electrolyte to the cathode side, where they are combined with oxygen to form water. The required electrons are supplied via the electrode:
½O₂+2H⁺+2e⁻→H₂O.

In the case of PEMFCs charge is transported through the electrolyte by means, for example, of migration of H₃O⁺ ions and/or proton hopping processes.

For practical implementation, an elementary cell such as this is normally embedded between two plate structures, which carry out various tasks. On the one hand, they are used to provide robustness for the MEA, which is generally flexible. Secondly, they are used for supplying and carrying away the reaction gases and for carrying away the resultant water. Thirdly, they can be used for heat management, that is to say in particular for dissipation of the waste heat that is created when separate channel structures for a heat carrier (in a liquid or gaseous form) are integrated or incorporated in the individual plates. Fourthly, they are used to output the current produced. Fifthly, these plate structures carry out sealing tasks since it is necessary to avoid the reaction gases mixing with one another, or passing over from one to the other, and/or mixing with the coolant, in all cases.

In the case of fuel cells which are formed from a stack of elementary cells, so-called stacks, the plate structures in each case separate the anode of a first elementary cell from the cathode of the adjacent elementary cell. They are thus frequently referred to as bipolar plates or in general as bipolar separators. In general, they are composed of graphite, graphite-polymer-composite materials or metals, or metal alloys. The separator plates which bound one section of a fuel-cell stack and to which there are no further adjacent elementary cells are, of course, not in the form of bipolar plates, but are monopolar plates. Both bipolar plates and monopolar plates will be referred to for the purposes of this description as “separator plates”.

External distribution/collection containers are frequently provided in order to supply the separator plates with reaction gases and/or coolant, and for carrying excess reaction gases and the resultant water and/or coolant away and are connected to the corresponding channel structures of the separator plates. One major factor in this case is good sealing of the various circuits from one another and from the environment, since any leakage leads to the heat carrier emerging and/or to inadvertent reaction gas mixing, which can lead to damage to the cells in the fuel-cell stack.

U.S. Pat. No. 6,660,422 B1, which has been cited, discloses a fuel-cell stack with an external distribution container for reaction gas. The container is in the form of a shroud whose edge rests via a solid seal on two end plates, which bound a section of the fuel-cell stack which is covered by the shroud. The individual fuel cell elements in the section are irregularly offset with respect to one another for manufacturing reasons, so that steps occur between individual elements which are sealed only inadequately by the solid seal to which there is a resultant gap. These steps or the gap are or is typically of the order of magnitude of about 0.1 mm.

In order to ensure that the shroud edge is seated in a sealed manner on the edges of the elementary cells over the entire fuel-cell stack, a second sealing layer is provided, composed of silicon rubber which cures at low temperatures. This material can be applied in liquid form to the edges of the elementary cells, and can then be cured, thus providing dimensionally stable compensation for the steps between the elementary cells. The solid seal then interacts with the flat surface of this second sealing layer, so that, overall, this results in reliable sealing of the shroud edge against the fuel-cell stack. If the distribution area is now filled with reaction gas, leakage to the outside is precluded, and all of the gas enters the channel inputs which are provided for the reaction gas in the separator plates.

This known seal has the disadvantage that, when individual fuel cell elements are replaced, the cured second sealing layer must be destroyed, at least in places. This is a result on the one hand of the considerable adhesion of the cured material to the edges of the elementary cells, and on the other hand as a result of the incomplete reproduceability of the offset when a new element is inserted. It is thus always necessary either to completely remove the second sealing layer and to apply a new one when a new element is used, or to reapply only a subarea, although breaks and leaks can occur at the points where the “old” seal joins the “new” sealing material.

The object of the present invention is to develop a fuel-cell stack of this generic type in such a manner that the sealing can be renewed in a less complex and more reliable manner than in the past after replacement of a fuel cell element.

In conjunction with the features in the preamble of claim 1, this object is achieved by the second sealing layer being composed of highly viscous, permanently flexible plastic material.

According to the invention and in contrast to the prior art, a plastic material which does not cure is used for the second sealing layer. It remains in a highly viscous, plastic, that is to say essentially viscofluid state, without any significant material conversion taking place. The required sealing effect and dimensional stability are ensured by the high viscosity, which is preferably between 5×10⁵ and 2×10⁶ mPas (millipascal seconds) and particularly preferably between 9.5×10⁵ and 1.65×10⁶ mPas.

Particularly for high-temperature fuel cells, the plastic material which is used for the permanently flexible seal is thermally stable in the range from −50° C. to at least +200° C., and particularly preferably at least briefly above +250° C.

Although those skilled in the art will be familiar with various materials such as these, the choice of a polyester resin or of a polyurethane is preferable. Materials such as these are available, for example, under the trade names Plast-o-Seal from Weicon GmbH & Co.KG, Münster, Germany, and under the name Hylomar from UKA-Knoch, Bruchsal, Germany.

The solid seal preferably extends over a section of the fuel cell arrangement which is bounded by two separator plates at the ends, on each of whose edges the solid seal rests, with no fuel cell element in the section projecting beyond the plane which is covered by the edges of the separator plates at the ends. This is advantageous because this allows the surface of the second sealing layer to be defined by the lower face of the solid seal on one plane. If individual elementary cells were to project beyond the plane defined by the edges of the separator plates at the ends, this would result in corresponding distortion of the solid seal, which in turn could lead to inadequate sealing of the collection/distribution container.

However, if the solid seal is appropriately thick and elastic, and is preferably in the form of a flat or profiled seal, it is possible to compensate for minor distortions such as this. The solid seal therefore preferably has only a medium to low hardness in the range Shore-A hardness 90 to 20. In particular, perfluoro monomer rubber (FFKM, FFPM), fluoro monomer rubber (FPM), fluorocarbon monomer rubber (FKM), fluoro silicon monomer rubber (MFQ, FVMQ), silicon monomer rubber (MVQ, VMQ), ethylene-propylene diene monomer rubber (EPDM) and others may be used as materials for the solid seal. These materials are particularly suitable for relatively high temperature ranges, that is to say high-temperature fuel cells with working temperatures up to about 200° C.

The seal according to the invention by means of second, permanently flexible sealing layer is highly suitable for step heights or gap widths of less than about 0.1 mm. If the step heights or gap widths are greater than this, the viscosity of the material may no longer be sufficient in order to allow sufficient dimensional stability and thus good sealing. One development of the invention therefore provides for a third sealing layer to be provided between the first sealing layer and the second sealing layer, composed of a plastic material which is applied in liquid form and is then cured. In this embodiment, the direct contact with the edges of the fuel-cell stack, which are not flat, is once again ensured by means of the permanently flexible, highly viscous, second sealing layer. Only those steps which it has not been possible to compensate for completely by this second sealing layer are advantageously compensated for by this additional, third layer composed of curing plastic. The third sealing layer can also ensure any filling required for the gap up to the level of the edges of the separator plates at the ends, on which the solid seal rests. By way of example, silicon monomer rubber (MVQ, VMQ) is suitable, inter alia, as a material for this purpose.

This third sealing layer admittedly has the disadvantage mentioned above in conjunction with the discussion relating to the prior art that it must be at least partially destroyed for replacement of a single fuel cell element. However, the problem is greatly reduced since, on the one hand, the adhesion between the third sealing layer and the fuel-cell stack is considerably reduced by the highly viscous, permanently flexible second sealing layer. On the other hand, possible incomplete areas at the boundary between the “old” and the “new” seal are not so important, since the major seal in the area at the edge of the fuel-cell stack is further ensured by the permanently flexible second sealing layer.

Owing to its essentially liquid state, the permanently flexible sealing material can be applied by a spray or by similar aids accurately in position in the form of a frame to the edges of the fuel-cell stack and, for example, can be made uniform by using a brush. In a next step, the solid seal can then be fitted, followed by the distribution container. The latter is braced with the stack via end plates. With regard to the sealing by means of three sealing layers, the permanently flexible seal is first of all applied in the manner mentioned above. The curing elastomer is applied in a second step, is made uniform (for example by pressing against a frame (composed of PTFE film or a similar material), and is cured. Depending on the choice of material, this can be done by temperature, moisture or in a similar manner. Once the frame for uniformity has been pulled off, the solid seal and the distribution container are then fitted.

The advantages of the invention are obvious. The invention thus allows fast assembly of stacks in prototype construction, in which elements are frequently used repeatedly, for cost reasons. There is no need to expend effort cleaning residues of cured sealing material off the plates. Furthermore, rapid replacement of individual deflected elements in the stack is possible, thus leading to time and cost savings. In addition, the fuel-cell stack can be recycled more easily on disposal, since there is no need for the effort to clean sealing material off the individual elements. Finally, the seal between the collection/distribution container and the fuel-cell stack is more reliable.

Further features and advantages of the invention result from the following, specific description, as well as the drawings.

In the figures:

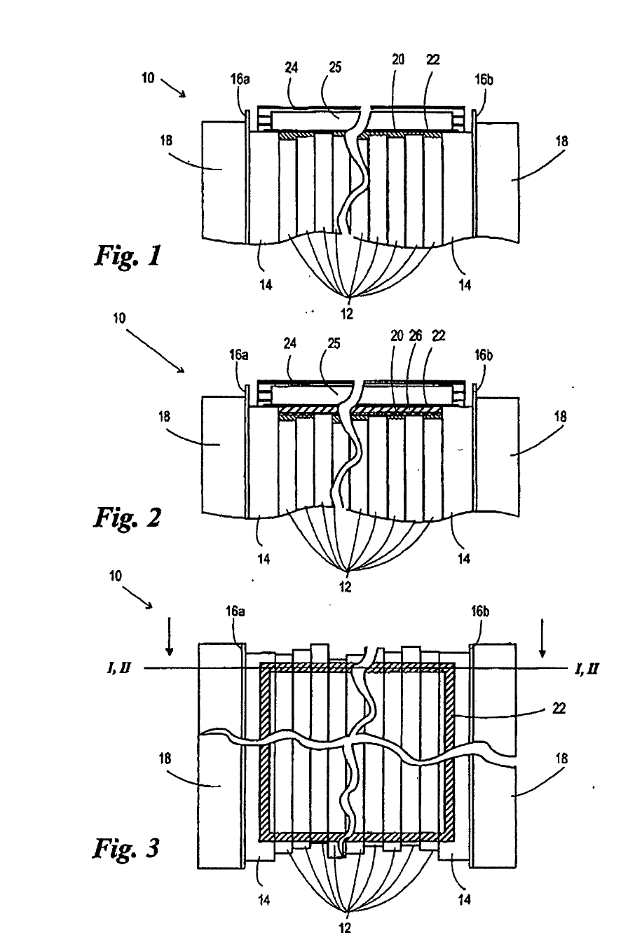

FIG. 1: shows a schematic sectional illustration of a first embodiment of a fuel-cell stack according to the invention;

FIG. 2: shows a schematic sectional illustration of a second embodiment of a fuel-cell stack according to the invention; and

FIG. 3 shows a schematic plan view of a fuel-cell stack according to the invention, before fitting of the collection/distribution container.

FIG. 1 shows the section view of a fuel-cell stack 10. The fuel-cell stack 10 is formed from a plurality of fuel cell elements 12. A section of the fuel-cell stack 10 which comprises a plurality of elements 12 is bounded by separator plates 14 at the ends, which make electrical contact with electrical output lines 16a, 16b of different polarity.

The fuel-cell stack 10 which in the illustrated exemplary embodiment is composed of only one stack section is bounded on the outside by end plates 18, via which the elements 12 are pressed together and held by means of a bracing apparatus, which is not illustrated, to form a stack.

For manufacturing reasons, the individual elements 12 in the structure of the stack can often not be placed flush against one another, so that steps occur between the edges of the individual elements, as can clearly be seen in the upper area of FIG. 1.

The invention provides for the steps between the elements 12 to be compensated for, in a sealing manner, by means of a permanently flexible, highly viscous sealing agent 20. The high viscosity provides sufficient dimensional stability in order to ensure permanent sealing. It should be noted that the steps between the elements 12 in FIG. 1 are exaggerated, and not shown to scale. Normal orders of magnitude of these steps are in the region of about 0.1 mm.

The upper surface of the sealing layer 20 in FIG. 1 forms the contact surface to a solid seal 22, which rests on the separator plates 14 at the ends, and covers the elements 12. The solid seal 22 which, for example, may be in the form of a flat or profiled seal seals the edges of a shroud-like collection/distribution container 24, which forms a sealed collection/distribution area 25, which makes contact with the edges of the elements 12.

FIG. 2 shows a further embodiment of the invention, which is advantageous in situations in which the steps between the elements 12 or the gap between the elements 12 and the solid seal 22 are or is greater than about 0.1 mm. In this situation as well, a layer 20 composed of permanently flexible, highly viscous sealing material is applied directly to the edges of the elements 12. However, a viscosity level which still allows liquid application by means of a brush or spray is not sufficient to bridge relatively large gaps with adequate dimensional stability. Thus, as is shown in FIG. 2, provision is made for a further sealing layer 26 composed of a curing elastomer to be arranged between the permanently flexible sealing layer 20 and the solid seal 22. Once this additional sealing layer 26 is cured, the required dimensional stability of the seal is ensured overall, but with the advantages which are obtained from the application according to the invention of a permanently flexible, highly viscous, lower sealing layer 20.

FIG. 3 shows a plan view of the fuel cell arrangement shown in FIGS. 1 and 2, but without the collection/distribution container fitted. The reference symbols stated in FIG. 3 correspond to those in FIGS. 1 and 2.

The exemplary embodiments explained in the specific description and in the figures naturally represent only illustrative embodiments of the invention, which can be modified in many ways by a person skilled in the art. In particular, the quantity, size and geometric arrangements of the element 12 in the fuel-cell stack 10 can be varied within wide limits. In addition, in contrast to the illustration in FIG. 2, the additional sealing layer 26 composed of elastomer which can be cured could also overlap the end plates 14, so that the shroud of the collection/distribution container 24 rests on a double sealing layer in the area of the separator plates 14 at the ends.

1. (canceled)

2. (canceled)

3. (canceled)

4. (canceled)

5. (canceled)

6. (canceled)

7. (canceled)

8. (canceled)

9. (canceled)

10. (canceled)

11. A fuel-cell stack having an external media supply comprises a plurality of stacked fuel cell elements (12) which each contain a proton-conducting polymer membrane that is arranged between a flat anode electrode and a flat cathode electrode, each electrode making contact with a separator plate, said separator plate having channel structures for supplying reaction gas, for carrying away excess reaction gas and water that is created and/or for distribution of a heat carrier, and furthermore having at least one collection/distribution container (24) which is connected to channel structures of a plurality of separator plates, for distribution of reaction gas or heat carrier or for collection of excess reaction gas and water that is created or heat medium, with the collection/distribution container being in the form of a shroud (24) which covers a plurality of fuel cell elements (12) and whose edge is sealed with respect to the fuel cell elements (12) that are covered, with said seal having at least one first sealing layer, which is in the form of a solid seal (22), and a second sealing layer (20), which makes direct contact with the fuel cell elements (12) being covered and at least partially compensates for steps between adjacent fuel cell elements, characterized in that the second sealing layer (20) is composed of a highly viscous permanently flexible plastic material.

12. The fuel-cell stack as claimed in claim 11, wherein the permanently flexible plastic material has a viscosity between 5×10⁵ and 2×10⁶ mPas.

13. The fuel-cell stack as claimed in claim 11, wherein the permanently flexible plastic material has a viscosity between 9.5×10⁵ and 1.65×10⁶ mPas.

14. The fuel-cell stack as claimed in claim 11, wherein the permanently flexible plastic material is thermally stable between −50° C. and at least +200° C.

15. The fuel-cell stack as claimed in claim 14, wherein the permanently flexible plastic material is thermally stable, at least briefly, at more than +250° C.

16. The fuel-cell stack as claimed in claim 11, wherein the permanently flexible plastic material is a polyester resin or a polyurethane.

17. The fuel-cell stack as claimed in claim 11, further including a third sealing layer (26) that is provided between the solid seal (22) and the second sealing layer (20) and is composed of a plastic material which is applied in liquid form and is then cured.

18. The fuel-cell stack as claimed in claim 11, wherein the solid seal (22) extends over a section of the fuel cell arrangement which is bounded by two separator plates (14) at the ends, on each of whose edges the solid seal (22) rests, with no fuel cell element (12) in the section projecting beyond the plane which is covered by the edges of the separator plates (14) at the ends.

19. The fuel-cell stack as claimed in claim 11, wherein the solid seal (22) is in the form of a flat or profiled seal.

20. The fuel-cell stack as claimed in claim 19, wherein the material of the solid seal (22) has a medium to low hardness in the range Shore-A 90 to 20.
